(19) United States
(12) Patent Application Publication
(10) Pub. No.: US 2005/0221104 A1
(43) Pub. Date: Oct. 6, 2005

(54) Sheet for packaging food and method for manufacturing it

(76) Inventors: Silvia Ortolani, Vicenza (IT); Roberta Ortolani, Vicenza (IT); Giuseppe Ortolani, Carmignano Di Brenta (IT); Renata Chilo, Carmignano Di Brenta (IT); Mara Ortolani, Carmignano Di Brenta (IT); Valeria Ortolani, Carmignano Di Brenta (IT)

Correspondence Address: MODIANO & ASSOCIATI, Via Meravigli, 16, MILANO, 20123, IT

(21) Appl. No.: 11/088,746

(22) Filed: Mar. 25, 2005

(30) Foreign Application Priority Data
Mar. 30, 2004 (IT) PD2004A000085

(51) Int. Cl. B32B 27/36; B32B 27/06

(52) U.S. Cl. 428/480; 428/34.2; 156/66

(57) ABSTRACT

A sheet for packaging food comprising a first layer made of paper that is coupled to a second layer made of polyethylene, a third metallic layer being deposited on the second polyethylene layer, and the second layer being coupled to the first layer on the side of the third metallic layer by interposing a fourth adhesive layer between the third metallic layer and the first paper layer.

The present invention relates to a sheet for packaging food.

The present invention also relates to a method for producing said sheet for packaging food.

### BACKGROUND OF THE INVENTION

Various kinds of sheet for packaging foods sold loose by weight, such as salami and cold pork meat, cheese, meat, bakery products and the like, are currently known.

Sheets of the type that comprises a first outer layer made of paper, coupled to a second inner layer made of polyethylene, are widely used.

Characteristic, distinctive and decorative markings are generally printed on the outer paper layer, while the polyethylene layer makes contact with the food in order to provide its best preservation.

These conventional types of sheet, while being widely used, have aspects that can be improved.

For example, such sheets are not able to act as a barrier to light and to infrared radiation, with important limitations for the preservation of the food, whose decomposition is facilitated by light.

Other known sheets have a paper layer on which a metalization operation deposits a layer of aluminum suitable to reflect light and infrared radiation.

However, these sheets can be placed in contact with the food only by means of their non-metalized side, due to the real risk of migration of the metal toward the food.

### SUMMARY OF THE INVENTION

The aim of the present invention is to provide a sheet for packaging food that is capable of obviating the problems and drawbacks of known types of sheet.

Within this aim, an object of the present invention is to provide a method for producing such a sheet for packaging food.

Another object of the present invention is to provide a waterproof sheet that ensures that the packaged food is protected against light and infrared radiation but also ensures that the aluminum does not migrate from the sheet.

Another object of the present invention is to provide a sheet that can be recycled easily and completely with respect to conventional types of sheet.

Another object of the present invention is to provide a sheet whose components are substantially biodegradable by composting.

Another object of the present invention is to provide a sheet for packaging food that is lighter, for an equal format used, than conventional types of sheet.

Another object of the present invention is to provide a sheet in which two portions thereof can be heat-sealed to each other, allowing to produce packages and containers that are sealed and are therefore also hermetic.

A further object of the present invention is to provide a sheet for packaging food that is capable of ensuring better preservation over time of the organoleptic characteristics and of the freshness and appearance of the packaged food.

A still further object of the present invention is to provide a sheet for packaging food that can be manufactured cheaply with known systems and technologies.

This aim and these and other objects that will become better apparent hereinafter are achieved by a sheet for packaging food, of the type that comprises a first layer made of paper that is coupled to a second layer made of polyethylene, characterized in that a third metallic layer is deposited on said second polyethylene layer, said second layer being coupled to said first layer on the side of the third metallic layer by interposing a fourth adhesive layer between said third metallic layer and said first paper layer.

The above aim and objects are also achieved by a method for manufacturing a sheet for packaging food according to the invention, comprising the steps of:
flash-metalizing a polyethylene terephthalate ribbon with aluminum powder in a high-vacuum environment;
spreading an adhesive layer on said polyethylene terephthalate ribbon, on the side of the layer of aluminum powder;
coupling a paper layer to said adhesive layer.

### BRIEF DESCRIPTION OF THE DRAWINGS

Further characteristics and advantages of the invention and of the method for manufacturing it will become better apparent from the following detailed description of a preferred but not exclusive embodiment thereof, illustrated by way of non-limiting example in the accompanying drawings, wherein:

FIG. 1 is a sectional view of a portion of sheet according to the invention;

FIG. 2 is a schematic view of the method for producing a sheet according to the invention.

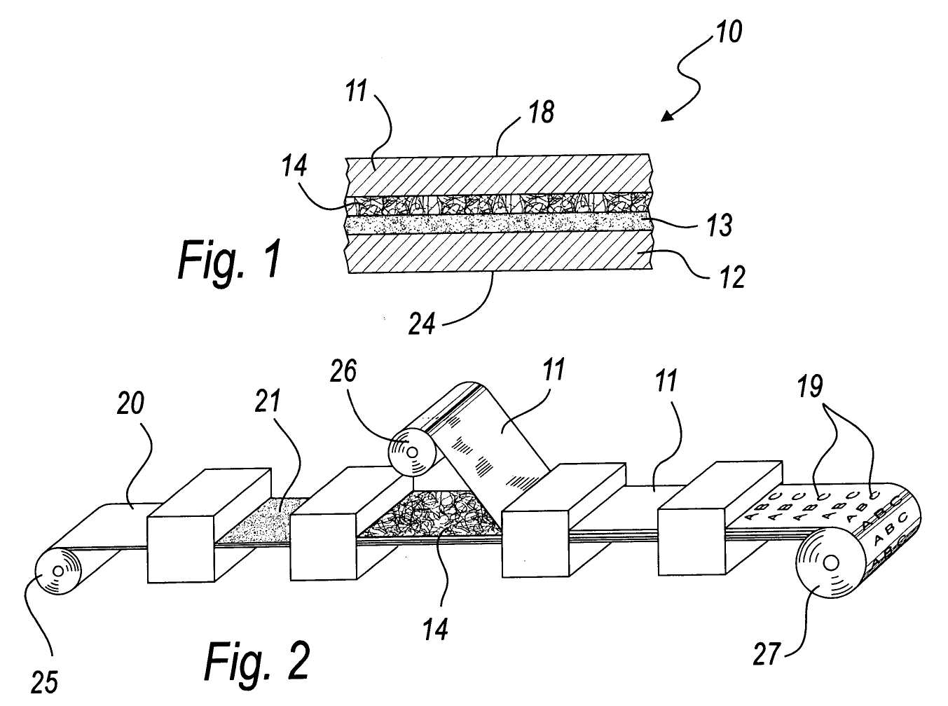

### DESCRIPTION OF THE PREFERRED EMBODIMENTS

With reference to the figures, a sheet for packaging food according to the invention is generally designated by the reference numeral 10.

The sheet 10 comprises a first layer 11 made of paper, which is coupled to a second layer 12 made of polyethylene.

A third metallic layer 13 is deposited on the second polyethylene layer 12.

The second layer 12 is coupled to the first layer 11 on the side of the third metallic layer 13 by interposing a fourth adhesive layer 14 between the third metallic layer 13 and the first paper layer 11.

The second layer 12 is made of polyethylene terephthalate.

The second layer 12 is selectively made of high-, medium- or low-density polyethylene terephthalate.

The second layer 12 made of polyethylene terephthalate (designated by the acronym PET hereinafter for the sake of simplicity) can also be obtained by coextrusion with mixtures having different molecular weight, in order to obtain particular preset technical characteristics, such as for example faster biodegradability.

In the embodiment described here, the third metallic layer 13 is advantageously made of aluminum powder.

The third aluminum layer 13 provides the sheet with the ability to reflect light and infrared radiation, facilitating preservation of the freshness of the food contained in the package.

The fourth adhesive layer 14 is based on vegetable starches and glucose.

The use of the adhesive layer 14 based on vegetable starches and glucose, in addition to performing in an optimum manner the function of making the third aluminum layer 13 and the first paper layer 11 adhere intimately by using only natural substances suitable for possible contact with food products, allows during disposal of the sheet 10 to separate easily the first layer 11 from the second layer 12 and the third layer 13.

This separation allows disposal of the various layers according to the criteria of sorted waste collection.

The position of the aluminum layer 13 between the paper layer 11 and the PET layer 12 prevents aluminum microparticles from separating from the sheet 10 to migrate onto the food, making it toxic and dangerous for the health of the consumer.

The present invention also relates to a method for producing a sheet 10 for packaging food as described above.

The method comprises the steps of:
flash-metalizing in a high-vacuum environment, with aluminum powder 21, which forms the third layer 13, a ribbon 20 made of polyethylene terephthalate that arrives from a first reel 25 and forms in turn the second layer 12;
spreading the adhesive layer 14 onto the polyethylene terephthalate ribbon 20, on the side of the aluminum powder layer 21;
coupling to the adhesive layer 14 the paper layer 11, unwound from a second reel 26.

High-vacuum flash metalization consists in sublimating and condensing, on a given substrate (in this case, the second PET layer 12), a thin film of metal (i.e., the third aluminum layer 13 in the example described here) in low-pressure conditions.

The low pressure (vacuum) allows the metal molecules to move from the evaporation source to the PET layer 12 without encountering the hindrance of air and of other gaseous particles.

The aluminum layer 13 is designed, as mentioned, to act as a barrier for light and at the same time reflect infrared radiation, also repelling the heat that said radiation would transmit to the food.

Following the adhesion of the paper layer 11 to the adhesive layer 14, it is possible to print on the outer face 18 of the paper layer 11, depending on the requirements of the seller, characteristic, distinctive or decorative markings 19.

In the case of the packaging of dry food, such characteristic, distinctive or decorative markings 19 can also be printed onto the outer face 24 of the polyethylene terephthalate layer 12.

The sheet 10 produced by this method is collected in a third reel 27.

According to requirements, the sheet 10 is cut into specific formats, for example for manual packaging of sliced or whole salami and cold pork meat products, both fresh and mature, cheese in slices and pieces, both soft and matured, fresh meat, et cetera.

The second layer 12, preferably made of high-density, low-molecular-weight PET, generally has a thickness between 6 and 6.5 microns, for a total maximum weight of 6 grams per square meter.

The third layer 13 of aluminum powder is provided by no more than 0.05 grams of aluminum powder per square meter, an amount that fully achieves the aim of acting as a barrier against light and infrared radiation.

The paper layer 11 weighs between 35 and 45 grams per square meter, plus 2 to 3 grams of adhesive layer 14 per square meter.

The total grammage of the sheet 10 therefore varies substantially between 44 and 54 grams per square meter.

This total weight is lower than the weight of known sheets that have a paper-aluminum bonding.

In order to produce bags for the bread-baking sector, the weight of the paper layer 11 is increased to 50-55 grams per square meter if it is necessary to carry 4 to 5 kilograms of food.

The materials used to produce the sheet 10, i.e., the paper of the first layer 11, the PET of the second layer 12, the aluminum powder of the third layer 13, and the adhesive of the fourth layer 14, are all biodegradable by composting in relatively short times: a few days for the adhesive and the paper, a few months for the PET, while the time for the aluminum is very long, but its quantity (0.05 grams per square meter) is so modest that it has a negligible environmental impact.

In practice, it has been found that the invention thus described solves the problems noted in known types of food packaging sheet.

Moreover, the present invention also provides a method for manufacturing such a food packaging sheet.

In particular, the present invention provides a waterproof sheet that ensures protection of the packaged food against the light and infrared radiation but also ensures that the aluminum does not migrate from the sheet.

Moreover, the present invention provides a sheet that can be recycled easily and completely with respect to known types of sheet.

Further, the present invention provides a sheet whose components are substantially biodegradable by composting in a natural environment.

Moreover, the present invention provides a food packaging sheet that is lighter, for an equal format used, than conventional types of sheet.

Moreover, the present invention provides a sheet in which two portions thereof can be mutually heat-sealed, allowing to produce packages and containers that are sealed and are therefore also hermetic.

The present invention also provides a food packaging sheet that is capable of ensuring better preservation over time of the organoleptic characteristics and of the freshness and appearance of the packaged food.

Finally, the present invention provides a food packaging sheet that can be manufactured cheaply with known systems and technologies.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2004A000085 from which this application claims priority are incorporated herein by reference.

1. A sheet for packaging food, of the type that comprises a first layer made of paper that is coupled to a second layer made of polyethylene, wherein a third metallic layer is deposited on said second polyethylene layer, said second layer being coupled to said first layer on the side of the third metallic layer by interposing a fourth adhesive layer between said third metallic layer and said first paper layer.

2. The sheet of claim 1, wherein said second layer is made of polyethylene terephthalate.

3. The sheet of claim 1, wherein said second layer is selectively made of high-, medium-, or low-density polyethylene terephthalate.

4. The sheet of claim 1, wherein said third metallic layer is made of aluminum powder.

5. The sheet of claim 1, wherein said fourth adhesive layer is based on vegetable starches and glucose.

6. A method for manufacturing a sheet for packaging food according to claim 1, comprising the steps of:
flash-metalizing a ribbon made of polyethylene terephthalate with aluminum powder on one side in a high-vacuum environment;
spreading an adhesive layer on said polyethylene terephthalate ribbon on the side of the aluminum powder layer;
coupling to said adhesive layer a paper layer.

7. The method of claim 6, wherein characteristic, distinctive or decorative markings are printed on said sheet, on an outer face of said paper layer, after the coupling to said adhesive layer.

8. The method of claim 6, wherein characteristic, distinctive or decorative markings are printed on said sheet on an outer face of said layer of polyethylene terephthalate.

9. The method of claim 6, wherein said sheet is collected in reels.
